(19) United States
(12) Patent Application Publication
(10) Pub. No.: US 2018/0264638 A1
(43) Pub. Date: Sep. 20, 2018

(54) Machine Tool Operating Device

(71) Applicant: Robert Bosch GmbH, Stuttgart (DE)

(72) Inventors: Cornelius Boeck, Kirchheim (DE); Daniel Barth, Leinfelden-Echterdingen (DE); Joachim Schadow, Stuttgart (DE); Joerg Maute, Sindelfingen (DE); Florian Esenwein, Leinfelden-Echterdingen (DE); Manfred Lutz, Filderstadt (DE)

(21) Appl. No.: 15/517,353

(22) PCT Filed: Nov. 18, 2015
(86) PCT No.: PCT/EP2015/076999

§ 371 Date: Apr. 6, 2017

(30) Foreign Application Priority Data
Dec. 9, 2014 (DE) 10 2014 225 329.2
Jul. 29, 2015 (DE) 10 2015 214 368.6

(51) Int. Cl. B25F 5/02; B24B 23/02; H01H 9/06; B23D 59/00; B23B 45/00

(52) U.S. Cl. CPC B25F 5/027; B24B 23/028; H01H 9/06; H01H 2300/026; B23B 45/001; B23B 2260/122; B25D 2250/221; B23D 59/002

(57) ABSTRACT

In one embodiment a power-tool operating device includes an operating unit that can be actuated by an operator. The power-tool operating device further includes an electronic unit to switch at least one energy supply of a drive unit based on the actuation of the operating element. The electronic unit has a locking switching function and a dead-man's switching function that can be selected at least partly automatically based on at least one of an actuation characteristic quantity of the operating element and sensed sensor characteristic quantity.

### PRIOR ART

A power-tool operating device, comprising an operating unit, which has an operating element that can be actuated by an operator, is already known from EP 1 563 962 B1. The already known power-tool operating device additionally comprises an electronic unit that is designed to switch at least one energy supply of a drive unit in dependence on an actuation of the operating element.

### DISCLOSURE OF THE INVENTION

The invention is based on a power-tool operating device, in particular a hand-held power-tool operating device, having at least one operating unit, which has at least one operating element that can be actuated by an operator, and having at least one electronic unit, which is designed at least to switch, in particular to activate or deactivate, at least one energy supply of a drive unit at least in dependence on an actuation of the operating element.

It is proposed that the electronic unit have at least one locking switching function and at least one dead-man's switching function, which are selectable at least partly automatically at least in dependence on an actuation characteristic quantity of the operating element and/or at least in dependence on at least one sensed sensor characteristic quantity. Preferably, an actuation of the operating element can be interrogated electronically by means of the electronic unit.

An at least partly automatic activation or a deactivation of the locking switching function or of the dead-man's switching function is effected preferably as the result of an electronic interrogation of an actuation characteristic quantity of the operating element and/or as the result of a sensor characteristic quantity. An “operating unit” is to be understood here to mean, in particular, a unit having at least one component, in particular the operating element and/or the further operating element, that can be actuated directly by an operator, and which is designed to influence and/or change a process and/or a state of a unit coupled to the operating unit as a result of an actuation and/or an input of parameters. An “operating element” is to be understood to mean, in particular, an element designed to receive an input quantity from an operator in an operating operation and, in particular, to be contacted directly by an operator, wherein touching of the operating element is sensed, and/or an actuating force exerted upon the operating element is sensed and/or transferred mechanically for the purpose of actuating a unit. “Designed” is to be understood to mean, in particular, specially configured, specially programmed and/or specially equipped. That an element and/or a unit are/is designed for a particular function is to be understood to mean, in particular, that the element and/or the unit fulfill/fulfills and/or execute/executes this particular function in at least one application state and/or operating state.

The operating element may be realized as a mechanical operating element or as an electronic operating element. Preferably, the operating element comprises a switching contact that can be switched as a result of an actuation of the operating element. The switching contact is preferably designed to generate a switching signal, realized as an electrical characteristic quantity, in dependence on an actuation of the operating element. The switching signal can preferably be transmitted to the electronic unit, and evaluated and processed further by the latter. The operating element is preferably realized as an electronic operating element, such as, for example, as a resistive, capacitive or inductive operating element. The operating unit may comprise a multiplicity of operating elements, which are realized as electronic operating elements, and the respective actuation of which can be interrogated electronically, in particular sensed electronically and processed further electronically, by the electronic unit. It is also conceivable, however, for the operating elements to be realized as mechanical operating elements, the respective actuation of which can be interrogated electronically, in particular sensed electronically and processed further electronically, by the electronic unit, such as, for example, by means of sensor elements or the like.

An “electronic unit” is to be understood to mean, in particular, a unit having at least one control electronics unit. A “control electronics unit” is to be understood to mean, in particular, a unit having a processor unit and having a storage unit, and having an operating program stored in the storage unit. The electronic unit is designed at least to select automatically the locking switching function and the dead-man's switching function at least in dependence on an actuation characteristic quantity and/or at least in dependence on a sensor characteristic quantity. The actuation characteristic quantity may be a sequence of a plurality of actuations in a predefined time period, a magnitude of an actuation force of an operator acting on the operating element, a movement, for example of at least one finger of an operator, or the like, on the operating element (swipe movement on the operating element, relative movement of two fingers on the operating element, drawing of a symbol on the operating element by means of at least one finger, or the like), or another characteristic quantity, considered appropriate by persons skilled in the art. The sensor characteristic quantity may be, for example, a bearing contact, sensed by means of a sensor unit, of at least one hand or a part of a hand of an operator on the operating element and/or on a further operating element of the operating unit, a distance of a hand of an operator from the operating element that can be sensed, for example by means of a sensor unit, or another characteristic quantity, considered appropriate by persons skilled in the art.

A “locking switching function” is to be understood here to mean, in particular, a function in which at least the operating element is locked in at least one position, or in which at least maintenance of an energy supply of a drive unit, following an actuation of the operating element, is at least substantially independent of the operating element remaining actuated. Preferably, the locking switching function is effected as a result of an electronic open-loop and/or closed-loop control by the electronic unit. In the case of the operating element being designed as a mechanical operating element, the locking switching function may be designed, for example, to control a locking element that fixes the operating element in a position in which an energy supply of the drive unit is activated. The locking element may be realized as a movable latching element that, as a result of an activation of the locking switching function, can be moved into a fixing position in which, by means of a form-fit and/or force-fit connection, it prevents the operating element from moving back into an initial position in which an energy supply of the drive unit is deactivated. The locking element may also be realized as a magnetic element that, as a result of an activation of the locking switching function, fixes the mechanical operating element, following an actuation by means of a magnetic force, in a position in which an energy supply of the drive unit is activated. Likewise conceivable are other designs of the locking element, for fixing the operating element realized as a mechanical operating element, that are considered appropriate by persons skilled in the art. In the case of the operating element being designed as an electronic operating element the locking switching function is preferably designed to control electronically, by open-loop and/or closed-loop control, maintenance of an energy supply of a drive unit. The locking switching function and the functioning thereof are to be considered to be known, at least substantially, by persons skilled in the art.

The term “dead-man's switching function” is intended here to define, in particular, a function in which, in particular, at least one energy supply of a drive unit can be prevented as a result of absence of an actuation of at least the operating element and/or of a further operating element. Preferably, the dead-man's switching function is designed to interrupt an energy supply of a drive unit as soon as the operating element and/or the further operating element are/is unactuated after an actuation has been effected, or an operator, after an actuation has been effected, removes a touch on the operating element and/or of the further operating element. The dead-man's switching function and the functioning thereof are to be considered to be known, at least substantially, by persons skilled in the art.

The design according to the invention makes it possible, advantageously, to provide a power-tool operating device that renders possible a variable switchover between a locking switching function and a dead-man's switching function. Thus, advantageously, a power-tool operating device that can be adapted to differing operators and/or fields of application can be realized. Moreover, advantageously, it is possible to provide a power-tool operating device that can be used in differing power tools. In addition, advantageously, a single power tool that is equipped with a power-tool operating device according to the invention can be used by differing operators of differing experience in operation of power tools. Thus, advantageously, in the case of an inexperienced operator, it is possible to prohibit switching of the locking function, and to enable only operation of the power tool in the dead-man's switching function.

Furthermore, it is proposed that the electronic unit have at least one evaluation unit, which is designed to select, at least partly automatically, the locking switching function or the dead-man's switching function at least in dependence on an actuation characteristic quantity realized as an actuation sequence of the operating element. Preferably, the actuation sequence of the operating element for selection between the locking switching function or the dead-man's switching function can be performed in a predefined time period. The predefined time period is, in particular, less than 20 seconds, preferably less than 10 seconds, and particularly preferably less than 5 seconds. If an operator actuates the operating element, for example, one single time within the predefined time period, automatic selection of the dead-man's switching function is effected by means of the evaluation unit. An interruption of the energy supply of the drive unit is effected in the dead-man's switching function preferably as a result of absence of an actuation of the operating element, in particular as a result of the operating element having been released, and/or as a result of a finger of a hand of an operator having been raised from the operating element, in particular as a result of force applied to the operating element having been removed. If an operator actuates the operating element, for example, at least twice in succession within the predefined time period, automatic selection of the locking switching function is effected by means of the evaluation unit. In the locking switching function, the energy supply of the drive unit is not interrupted preferably in the case of absence of an actuation of the operating element, in particular as a result of the operating element having been released, and/or as a result of a finger of a hand of an operator having been raised from the operating element. Advantageously, convenient operation can be achieved by means of the design according to the invention.

Further, it is proposed that the electronic unit have at least one sensor unit, which is designed to sense at least one sensor characteristic quantity, realized as a proximity and/or contact characteristic quantity, in dependence on which the locking switching function or the dead-man's switching function is selectable at least partly automatically. The sensor unit can advantageously sense a contact, at least between the operating element and an operator, in particular an application of a hand of an operator to at least the operating element, and/or a small distance, at least between the operating element and an operator, that can be taken into account in a selection of the locking switching function or the dead-man's switching function. Advantageously, it is possible to sense in a particularly reliable manner a secure grip by an operator that can be taken into account in a selection of the locking switching function or the dead-man's switching function.

It is additionally proposed that the sensor unit have at least one sensor element, which is realized as a contact sensor. The sensor element in this case may be realized as a membrane switch, as an optical sensor element (light barrier, etc.), or as another sensor element considered appropriate by persons skilled in the art, that is designed to sense a contact, in particular a touch. By means of the design according to the invention, a contact, in particular a touch, by an operator can be sensed in an advantageously reliable manner.

Furthermore, it is proposed that the electronic unit have at least one communication unit that is designed for communication with an external unit, wherein the locking switching function or the dead-man's switching function is selectable at least partly automatically in dependence on the communication with the external unit. The communication unit is preferably realized as a wireless communication unit. The communication unit in this case may be realized as a WLAN communication unit, as a Bluetooth communication unit, as a radio communication unit, as an RFID communication unit, as an NFC unit, as an infrared communication unit, as a mobile telephony communication unit, as a Zigbee communication unit, or the like. Particularly preferably, the communication unit is designed for bidirectional data transmission. In an alternative design, the communication unit is realized as a wired communication unit such as, for example, a LAN communication unit, a USB communication unit, as a Powerline communication unit, as a CAN-bus Communication unit, as an Ethernet communication unit, as a twisted-pair cable communication unit (CAT5 or CAT6), or the like. It is also conceivable, however, that the communication unit, as an alternative to being designed for wireless or wired communication, is designed for wireless and wired communication. The external unit may be realized as a portable data processing unit such as, for example, as a smartphone, as a laptop, as a tablet PC, etc., as a company central computer, as a router, or as another external unit considered appropriate by persons skilled in the art. Alternatively or additionally, it is conceivable for the power-tool operating device to have at least one input unit, by means of which a manual selection can be made between the locking switching function and the dead-man's switching function, in particular following input of an authorization code. Advantageously, transmission of electronic data, which can be taken into account in a selection of the locking switching function or the dead-man's switching function, can be effected by means of the design according to the invention. For example, electronic operator-specific data that can be transmitted to the electronic unit by means of the communication unit are stored in an electronic operator module that is worn on the body by an operator, the electronic unit deciding, on the basis of the evaluation function of the evaluation unit, whether the locking switching function or the dead-man's switching function is activated.

Also proposed is a power tool, in particular a portable power tool, having at least one power-tool operating device according to the invention. A “portable power tool” is to be understood here to mean, in particular, a power tool, for performing work on workpieces, that can be transported by an operator without the use of a transport machine. In particular, the portable power tool has a mass of less than 40 kg, preferably less than 10 kg, and particularly preferably less than 5 kg. The portable power tool may be realized as a portable angle grinder, as hand-held circular saw, as a power drill, as a percussion power drill, as a jigsaw, as a multifunction power tool, as a power plane, as a router, or as another power tool considered appropriate by persons skilled in the art, in particular as a portable, electrically operated power tool. By means of the design according to the invention, particularly advantageously, it is possible to provide a power tool that renders possible a variable switchover between a locking switching function and a dead-man's switching function. Thus, advantageously, a power tool that can be adapted to differing operators and/or fields of application can be realized. Advantageously, a single power tool can be used by differing operators of differing experience in operation of power tools. In particular, cost savings can be made in a company resource pool of power tools, since one design of a power tool can be used by two operators of differing experience.

Additionally proposed is a method for operation of a power tool according to the invention, in particular for putting the same into operation. Advantageously, convenient operation can be achieved by means of the design according to the invention.

Furthermore, it is proposed that an at least partly automatic selection of the locking switching function or the dead-man's switching function be effected, in at least one method step, in dependence on an actuation sequence of the operating element in relation to a predefined time period. Particularly advantageously, an unintentional switchover between the locking switching function and the dead-man's switching function can be largely prevented. Moreover, advantageously, an unintentional deactivation of the dead-man's switching function can be avoided.

It is additionally proposed that an at least partly automatic selection of the locking switching function or the dead-man's switching function be effected, in at least one method step, in dependence on at least one proximity and/or contact characteristic quantity sensed by means of a sensor unit of the electronic unit. For example, it is conceivable that the locking switching function be selectable only after it is identified that the power tool is being held, or gripped, securely. Thus, advantageously, a high degree of operating safety can be realized.

It is additionally proposed that an at least partly automatic selection of the locking switching function or the dead-man's switching function be effected, in at least one method step, in dependence on an operator-specific characteristic quantity received by means of a communication unit of the electronic unit. The operator-specific characteristic quantity may be realized as a work authorization, as a training level, as a physical capability, or the like. Particularly convenient operation of the power tool can be achieved by means of the design according to the invention, since a selection of the locking switching function or dead-man's switching function is effected at least substantially automatically.

The power-tool operating device according to the invention, the power tool according to the invention and/or the method according to the invention are/is not intended in this case to be limited to the application and embodiment described above. In particular, the power-tool operating device according to the invention, the power tool according to the invention and/or the method according to the invention may have individual elements, components and units, and method steps, that differ in number from a number stated herein, in order to fulfill a principle of function described herein.

Moreover, in the case of the value ranges specified in this disclosure, values lying within the stated limits are also to be deemed as disclosed and applicable in any manner.

### DRAWING

Further advantages are disclosed by the following description of the drawing. Four exemplary embodiments are represented in the drawing. The drawing, the description and the claims contain numerous features in combination. Persons skilled in the art will also expediently consider the features individually and combine them to create appropriate further combinations.

There are shown in:

FIG. 1 a power tool according to the invention, having at least one power-tool operating device according to the invention, in a schematic representation,

FIG. 2 an alternative power tool according to the invention, having at least one power-tool operating device according to the invention, in a schematic representation,

FIG. 3 a further alternative power tool according to the invention, having at least one power-tool operating device according to the invention, in a schematic representation, and

FIG. 4 a further alternative power tool according to the invention, having at least one power-tool operating device according to the invention, in a schematic representation.

### DESCRIPTION OF THE EXEMPLARY EMBODIMENTS

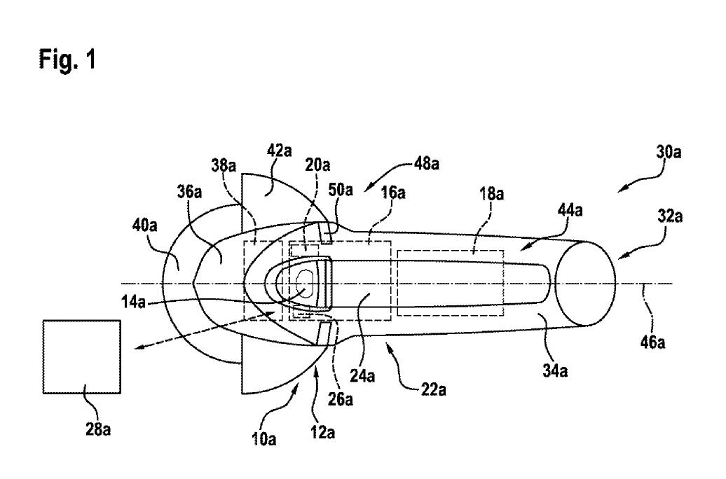

FIG. 1 shows a power tool 30a, having at least one power-tool operating device 10a. The power tool 30a is realized as a portable power tool. In the exemplary embodiment represented in FIG. 1, the power tool 30a is realized as an angle grinder. It is also conceivable, however, for the power tool 30a to be of another design, considered appropriate by persons skilled in the art. The power tool 30a comprises at least one housing unit 32a, which comprises at least one motor housing 34a that is designed to accommodate a drive unit 18a of the power tool 30a. The drive unit 18a is realized as an electric-motor unit. The housing unit 32a additionally comprises a transmission housing 36a for accommodating an output unit 38a of the power tool 30a. The drive unit 18a is designed to drive, in particular to drive in rotation, via the output unit 38a, a working tool 40a that can be disposed on a tool receiver (not represented in greater detail) of the power tool 30a. The working tool 40a is realized as a grinding disk. It is also conceivable, however, for the working tool 40a to be realized as a cutting disk or polishing disk. The power tool 30a additionally comprises at least one protective hood unit 42a. The protective hood unit 42a surrounds the working tool 40a, at least along an angular range of more than 120°, when the working tool 40a is disposed on the tool receiver.

The power-tool operating device 10a comprises at least one operating unit 12a, which has at least one operating element 14a that can be actuated by an operator. The power-tool operating device 10a additionally comprises at least one electronic unit 16a, which is designed at least to switch at least one energy supply of the drive unit 18a at least in dependence on an actuation of the operating element 14a. The electronic unit 16a is additionally designed to control, by open-loop and/or closed-loop control, a characteristic quantity of the drive unit 18a, such as, for example, a rotational speed (an idling rotational speed, a working rotational speed, or the like), a torque, or another characteristic quantity considered appropriate by persons skilled in the art.

The operating element 14a is realized as a mechanical operating element. The operating element 14a in this case may be mounted so as to be rotatable, translationally movable and/or pivotable, in particular on the housing unit 32a. It is also conceivable, however, for the operating element 14a to be of another design, considered appropriate by persons skilled in the art, such as, for example, designed as an electronic switching element such as, for example, as a resistive, capacitive or inductive operating element, or the like. The operating element 14a is disposed on a side of the transmission housing 36a that faces away from the tool receiver. It is also conceivable, however, for the operating element 14a to be disposed at another position on the housing unit 32a, considered appropriate by persons skilled in the art. The operating element 14a has at least one switching contact (not represented in greater detail here), which can be opened or closed in dependence on a movement of the operating element 14a. The operating element 14a has signal connection to the electronic unit 16a. A signal that can be generated as a result of an opening or closing of the switching contact of the operating element 14a can be transmitted to the electronic unit 16a as a result of a signal connection of the operating element 14a to the electronic unit 16a. The electronic unit 16a is designed to process the signal, which can be generated by means of the operating element 14a, in particular by means of the switching contact of the operating element 14a.

Furthermore, the electronic unit 16a has at least one locking switching function and at least one dead-man's switching function, which are selectable at least partly automatically at least in dependence on an actuation characteristic quantity of the operating element 14a and/or at least in dependence on at least one sensed sensor characteristic quantity. The electronic unit 16a additionally has at least one evaluation unit 20a, which is designed to select, at least partly automatically, the locking switching function or the dead-man's switching function at least in dependence on an actuation characteristic quantity realized as an actuation sequence of the operating element 14a.

The electronic unit 16a additionally comprises at least one sensor unit 22a, which is designed to sense at least one sensor characteristic quantity, realized as a proximity and/or contact characteristic quantity, in dependence on which the locking switching function or the dead-man's switching function is selectable at least partly automatically. The sensor unit 22a has at least one sensor element 24a, which is realized as a contact sensor. The sensor element 24a is designed to sense at least one finger or one hand of an operator being applied to the housing unit 32a, and/or to sense the housing unit 32a being gripped by at least one hand of the operator. The sensor element 24a may be realized as a contact switch, as a membrane switch, as a light barrier, or the like. For the purpose of protection, the sensor element 24a may be disposed under a flexible protective element (not represented in greater detail here) of the operating unit 12a, such as, for example, an elastomer element, or the like. The sensor element 24a is disposed on a handle region 44a of the housing unit 32a. The sensor element 24a is disposed on a side of the handle region 44a that faces away from the tool receiver. It is also conceivable, however, for the sensor element 24a to be disposed at another position on the housing unit 32a, considered appropriate by persons skilled in the art, such as, for example, on a side of the handle region 44a that faces toward the tool receiver. The handle region 44a is constituted by a sub-region of the transmission housing 36a. It is also conceivable, however, for the housing unit 32a to have a handle that is disposed on the transmission housing 36a, and that is realized so as to be at least substantially free from a mounting of the drive unit 18a and/or of the output unit 38a.

The sensor element 24a, in particular along an axis of main extent 46a of the power tool 30a, has a maximum extent that corresponds to at least more than 10% of a maximum extent of the transmission housing 36a along the axis of main extent 46a. Preferably, the maximum extent of the sensor element 24a along the axis of main extent 46a corresponds to at least more than 50% of a maximum extent of the transmission housing 36a along the axis of main extent 46a. Most particularly preferably, the maximum extent of the sensor element 24a along the axis of main extent 46a corresponds to at least more than 80% of a maximum extent of the transmission housing 36a along the axis of main extent 46a. The power tool 30a has a maximum extent along the axis of main extent 46a. The axis of main extent 46a is at least substantially parallel to a direction that, starting from the transmission housing 36a, goes in the direction of the motor housing 34. In the case of the power tool 30a designed as an angle grinder, the axis of main extent 46a is at least substantially parallel to a rotation axis of the drive unit 18a.

The electronic unit 16a has at least one communication unit 26a, which is designed to communicate with an external unit 26a, the locking switching function or the dead-man's switching function being selectable at least partly automatically in dependence on the communication with the external unit 26a. The communication unit 26a is realized as a wireless communication unit. By means of the communication unit 26a, electronic data can be transmitted from the external unit 28a to the electronic unit 16a for further processing. The external unit 28a has at least one storage unit (not represented in greater detail here), in which operator-specific characteristic quantities can be stored. As a result of being transmitted to the electronic unit 16a, the operator-specific characteristic quantities can be evaluated by means of the evaluation unit 20 regarding an activation of the locking switching function or of the dead-man's switching function.

Furthermore, the power tool 30a comprises at least one output unit 48a, which is designed at least to output to an operator at least one item of information regarding a selection of the locking switching function or the dead-man's switching function. The output unit 48a comprises at least one output element 50a. The output element 50a is realized as an optical output element. The output element 50a is realized as an LED. It is also conceivable, however, for the output element 50a to be of another design, considered appropriate by persons skilled in the art, such as, for example, designed as an acoustic output element (loudspeaker or the like), as a haptic output element (vibration generator or the like), as a display (LCD, LED display, AMOLED display or the like), or as another output element considered appropriate by persons skilled in the art. Moreover, it is conceivable for the output unit 48a to have a multiplicity of output elements 48a, which may differ in design or be of like design, such as, for example, an LED and a display, or the like. The output unit 48a can be controlled by means of the electronic unit 16a.

A method for operating the power tool 30a, in particular for putting it into operation, is explained in the following. The operating element 14a can be actuated for the purpose of putting the power tool 30a into operation, in particular for the purpose of feeding electric current to the drive unit 18a. The actuation of the operating element 14a can be sensed by the electronic unit 16a. If the sensor unit 22a senses an application, in particular of a part, of a hand of an operator on the sensor element 24a, an energy supply of the drive unit 18a can be activated. When the power tool 30a is in an initial state, the dead-man's switching function is selected automatically. An at least partly automatic selection of the dead-man's switching function is effected, in at least one method step, in dependence on at least one proximity and/or contact characteristic quantity sensed by means of the sensor unit 22a of the electronic unit 16a. The energy supply of the drive unit 18a is deactivated by the electronic unit 16a upon the hand of the operator, in particular a part of the hand of the operator, being raised from the sensor element 24a. A deactivation of the energy supply of the drive unit 18a following an activation of the dead-man's switching function can be achieved by a renewed actuation of the operating element 14a, or by removal of an operator contact on the operating element 14a or on the sensor element 24a.

If, by means of a communication between the communication unit 26a and the external unit 28a, an authorization clearance is effected for an activation of the locking switching function, in particular as a result of a transmission of operator-specific characteristic quantities, selection of the locking switching function is possible. It is conceivable for a fully automatic selection of the locking switching function or the dead-man's switching function to be effected, in at least one method step, in dependence on an operator-specific characteristic quantity received by means of the communication unit 26a of the electronic unit 16a. Alternatively or additionally, an operator may select between locking switching function and dead-man's switching function, in particular following a clearance by means of a communication between the communication unit 26a and the external unit 28a. An at least partly automatic selection of the locking switching function or of the dead-man's switching function is effected by means of the electronic unit 16a, in at least one method step, in dependence on an actuation sequence of the operating element 14a in relation to a predefined time period. If the operator actuates the operating element 14a within a predefined time period, for example twice, an at least partly automatic selection of the locking switching function is effected by means of the electronic unit 16a. When the locking switching function has been activated, an operator can release the operating element 14a and/or the sensor element 24a, without the energy supply of the drive unit 18a being deactivated. A deactivation of the energy supply of the drive unit 18a following an activation of the locking switching function can be achieved by a renewed actuation of the operating element 14a, in particular by a renewed actuation of the operating element 14a following an activation of the locking switching function and/or when the operating element 14a is in a fixed position. If the operator actuates the operating element 14a within the predefined time period, for example only once, at an least partly automatic selection of the dead-man's switching function is effected by means of the electronic unit 16a.

If the electronic unit 16a is realized such that it is separate from the sensor unit 22a, an activation of the locking switching function is effected in dependence on an actuation sequence of the operating element 14a within a predefined time period such as, for example, as a result of actuation twice within a predefined time period of less than 5 seconds (actuation, release and renewed actuation within the predefined time period). The actuation sequence is interrogated by the electronic unit 16a and evaluated accordingly, in order to activate, at least partly automatically, the locking switching function. When the locking switching function has been activated, the energy supply of the drive unit 18a remains activated, even after the operating element 14a has been released. For the purpose of deactivating the energy supply of the drive unit 18a when the locking switching function has been activated, the operating element 14a can be actuated once more, in particular once more following an actuation of the operating element 14a for the purpose of activating the locking switching function and/or when the operating element 14a is in a fixed position.

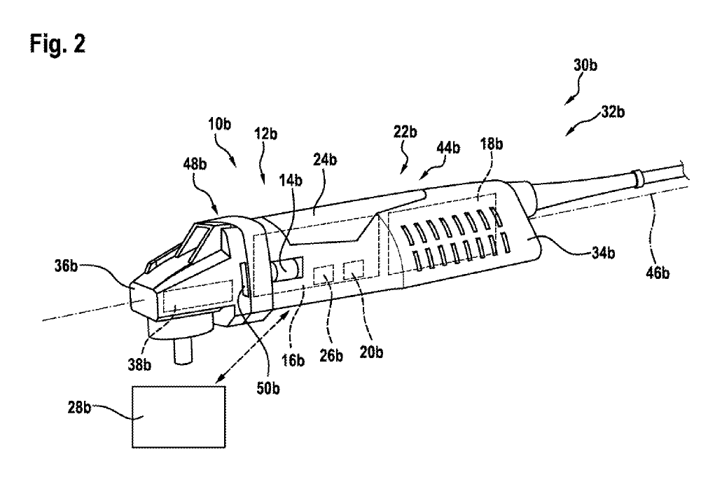

Further exemplary embodiments of the invention are shown in FIGS. 2 to 4. The descriptions and the drawing that follow are limited substantially to the differences between the embodiments, and in principle reference may also be made to the drawing and/or the description of the other embodiments, in particular of FIG. 1, in respect of components that have the same designation, in particular in respect of components denoted by the same references. To distinguish the exemplary embodiments, the letter a has been appended to the references of the exemplary embodiment in FIG. 1. In the exemplary embodiments of FIGS. 2 to 4, the letter a has been replaced by the letters b to d.

FIG. 2 shows an alternative power tool 30b, having at least one power-tool operating device 10b. The power tool 30b represented in FIG. 2 is of a design that is at least substantially similar to the power tool 30a represented in FIG. 1. Unlike the power tool 30a represented in FIG. 1, the power tool 30b represented in FIG. 2 comprises a power-tool operating device 10b having at least one operating unit 12b, which comprises at least one operating element 14b that is disposed on a side region of a housing unit 32b of the power tool 30b. The operating unit 12b may additionally have a further operating element (not represented in greater detail here), which is disposed on a further side region of the housing unit 32b that faces away from the side region. Advantageously, a power-tool operating device 10b suitable for left-handed or right-handed operation can be realized by simple design means. Regarding further features and functions of the power tool 30b represented in FIG. 2, reference may be made to the description of the power tool 30a represented in FIG. 1.

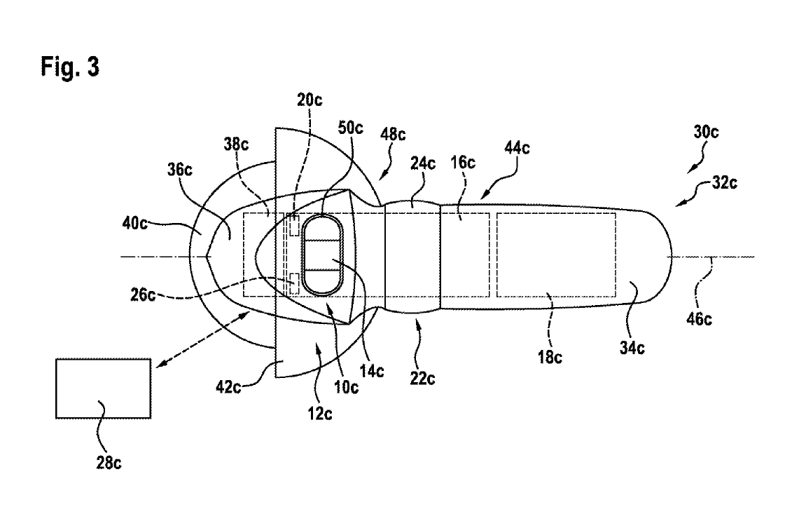

FIG. 3 shows a further alternative power tool 30c, having at least one power-tool operating device 10c. The power tool 30c represented in FIG. 3 is of a design that is at least substantially similar to the power tool 30a represented in FIG. 1. Unlike the power tool 30a represented in FIG. 1, the power tool 30c represented in FIG. 3 comprises a power-tool operating device 10c having an electronic unit 16c that has at least one sensor unit 22c, which has at least one sensor element 24c that extends at least substantially entirely around a housing unit 32c of the power tool 30c. The sensor element 24c, as viewed along a circumferential direction of the power tool 30c, has a maximum extent that corresponds to at least 25% of a maximum total circumferential extent of the housing unit 32c. In particular, the sensor element 24c, as viewed along the circumferential direction, has a maximum extent that corresponds to at least 50% of the maximum total circumferential extent of the housing unit 32c. Preferably, the sensor element 24c, as viewed along the circumferential direction, has a maximum extent that corresponds to at least 70% of the maximum total circumferential extent of the housing unit 32c. Particularly preferably, the sensor element 24c, as viewed along the circumferential direction, has a maximum extent that corresponds to at least 100% of the maximum total circumferential extent of the housing unit 32c. The circumferential direction runs, in particular, in a plane occurring substantially perpendicularly in relation to a rotation axis of a drive element of a drive unit 18c of the power tool 30c, in particular of a rotor shaft of the drive unit 18c realized as an electric-motor unit. The power tool 30c additionally comprises at least one output unit 48c, which is realized so as to be at least partly integral with the operating unit 12c of the power-tool operating device 10c. The output unit 48c is realized as a touch-sensitive display. An operating element 14c of the operating unit 12c is realized as an electronic operating element. Regarding further features and functions of the power tool 30c represented in FIG. 3, reference may be made to the description of the power tool 30a represented in FIG. 1.

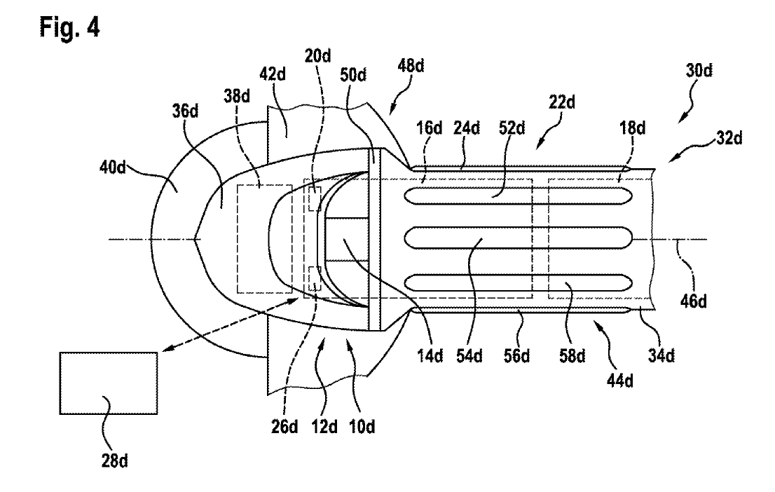

FIG. 4 shows a further alternative power tool 30d, having at least one power-tool operating device 10d. The power tool 30d represented in FIG. 4 is of a design that is at least substantially similar to the power tool 30a represented in FIG. 1. Unlike the power tool 30a represented in FIG. 1, the power tool 30d represented in FIG. 4 comprises a power-tool operating device 10d having an electronic unit 16d that has at least one sensor unit 22d, which has a multiplicity of sensor elements 24d, 52d, 54d, 56d, 58d. The sensor elements 24d, 52d, 54d, 56d, 58d, as viewed along a circumferential direction of the power tool 30d, are disposed on a housing unit 32d, with a mutual spacing relative to one another. The sensor elements 24d, 52d, 54d, 56d, 58d, as viewed along the circumferential direction of the power tool 30d, are disposed around the housing unit 32d with a uniform distribution along the circumferential direction. It is also conceivable, however, for the sensor elements 24d, 52d, 54d, 56d, 58d to be disposed around the housing unit 32d with a non-uniform distribution along the circumferential direction. An operating element 14d of an operating unit 12d is realized as an electronic operating element. Regarding further features and functions of the power tool 30d represented in FIG. 4, reference may be made to the description of the power tool 30a represented in FIG. 1.

1. A power-tool operating device, comprising:
at least one operating unit having at least one operating element configured to be actuated by an operator; and
at least one electronic unit configured to switch at least one energy supply of a drive unit based on an actuation of the at least one operating element,
wherein the at least one electronic unit has at least one locking switching function and at least one dead-man's switching function, the at least one locking switching function and the at least one dead-man's switching function configured to be selectable at least partly automatically based on at least one of (i) an actuation characteristic quantity of the at least one operating element and (ii) at least one sensed sensor characteristic quantity.

2. The power-tool operating device as claimed in claim 1, wherein the electronic unit has at least one evaluation unit configured to select, at least partly automatically, the locking switching function or the dead-man's switching function based on an actuation characteristic quantity, and
wherein the actuation characteristic quantity is an actuation sequence of the operating element.

3. The power-tool operating device as claimed in claim 1, wherein the at least one electronic unit further has at least one sensor unit configured to sense at least one sensor characteristic quantity, the at least one sensor characteristic quantity being at least one of (i) a proximity and (ii) a contact characteristic quantity, and
wherein the electronic unit is configured to select the locking switching function or the dead-man's switching function at least partly automatically based on the at least one sensor characteristic quantity.

4. The power-tool operating device as claimed in claim 3, wherein the sensor unit has at least one sensor element, and
wherein the at least one sensor element is a contact sensor.

5. The power-tool operating device as claimed in claim 1, wherein the at least one electronic unit has at least one communication unit that is configured for communication with an external unit, and
wherein the locking switching function or the dead-man's switching function is selectable at least partly automatically based on the communication with the external unit.

6. A power tool comprising:
at least one power-tool operating device, the at least one power-tool operating device including:
at least one operating unit having at least one operating element configured to be actuated by an operator; and
at least one electronic unit configured to switch at least one energy supply of a drive unit based on an actuation of the at least one operating element,
wherein the at least one electronic unit has at least one locking switching function and at least one dead-man's switching function, the at least one locking switching function and the at least one dead-man's switching function configured to be selectable at least partly automatically based on at least one of (i) an actuation characteristic quantity of the at least one operating element and (ii) at least one sensed sensor characteristic quantity.

7. A method for operation of a power tool, comprising:
actuating an operating element of an operating unit;
when a sensor unit senses a first sensor characteristic quantity, activating an energy supply of a drive unit;
when the power tool is in an initial state, selecting at least automatically a dead-man's switching function; and
when the sensor unit senses a second sensor characteristic quantity, deactivating energy supply of the drive unit,
wherein the operating unit is included in a power-tool operating device and the power-tool operating device is included in the power tool,
wherein the sensor element is included in the sensor unit, the sensor unit is included in an electronic unit, and the electronic unit is included in the power-tool operating device,
wherein the first sensor characteristic quantity and the second sensor characteristic quantity is at least one of (i) a proximity and (ii) a contact characteristic quantity, and
wherein the dead-man's switching function is included in the electronic unit.

8. The method as claimed in claim 7, further comprising:
effecting an at least partly automatic selection of the locking switching function or the dead-man's switching function based on an actuation sequence of the operating element in relation to a predefined time period.

9. The method as claimed in claim 7, further comprising:
effecting an at least partly automatic selection of the locking switching function or the dead-man's switching function based on at least one of (i) at least one proximity and (ii) contact characteristic quantity sensed using the sensor unit of the electronic unit.

10. The method as claimed in claim 7, further comprising:
effecting an at least partly automatic selection of the locking switching function or the dead-man's switching function based on an operator-specific characteristic quantity received using a communication unit of the electronic unit.

11. The power tool as claimed in claim 6, wherein the power tool is a portable power tool.

12. The method as claimed in claim 7, wherein the method is for putting the power tool in operation.
